(19) United States
(12) Patent Application Publication
(10) Pub. No.: US 2010/0069541 A1
(43) Pub. Date: Mar. 18, 2010

(54) Dispersant Composition

(75) Inventors: Dean Thetford, Norden (GB); Patrick J. Sunderland, Rossendale (GB)

Correspondence Address: LEGAL DEPARTMENT;LUBRIZOL ADVANCED MATERIALS, INC, 9911 BRECKSVILLE ROAD, CLEVELAND, OH, 44141-3247, US

(73) Assignee: LUBRIZOL LIMITED, Derby, Derbyshire (GB)

(21) Appl. No.: 12/532,711

(22) PCT Filed: Mar. 28, 2008
(86) PCT No.: PCT/EP08/53717

§ 371 Date: Sep. 23, 2009

Related U.S. Application Data
(60) Provisional application No. 60/908,429, filed on Mar. 28, 2007.

(51) Int. Cl. C08K 5/524; C07F 9/38

(52) U.S. Cl. 524/131; 562/24

(57) ABSTRACT

The invention relates to a composition containing a particulate solid, an organic or aqueous medium, and a compound with a head group derived from phosphorous acid. The invention further relates to novel compounds, and the use of the compound as a dispersant.

### FIELD OF INVENTION

The invention relates to a composition containing a particulate solid, an organic or aqueous medium, and a compound with a head group derived from phosphorous acid. The invention further relates to novel compounds, and the use of the compound as a dispersant.

### BACKGROUND OF THE INVENTION

Dispersants containing terminal acidic groups such as phosphates and sulphates are known and are generally prepared by reaction of a hydroxy ended polymer chain with phosphorus pentoxide, phosphorus oxychloride, phosphorus trichloride and pentachloride, polyphosphoric acid or sulphuric acid. The polymer chains are usually polyester or polyalkoxylate chains containing terminal hydroxyl groups.

U.S. Pat. No. 5,300,255 discloses dispersants containing a polyester derived from a hydroxycarboxylic acid with not more than 8 carbon atoms reacted with phosphorus pentoxide or sulphuric acid. The dispersants are useful in non-polar media, such as aromatic solvents and plastics.

U.S. Pat. No. 5,130,463 discloses dispersants containing a polyether/polyester derived from ε-caprolactone reacted with polyphosphoric acid. The dispersants are useful in a polar medium, such as ketones and esters.

U.S. Pat. No. 6,051,627 discloses dispersants including a polyether derived from ethylene oxide and propylene oxide reacted with polyphosphoric acid. The dispersants are useful in a polar medium such as ketones, esters and water.

U.S. Pat. Nos. 5,464,895 and 5,412,139 both disclose polyaryl organophosphate dispersing agents.

U.S. Pat. Nos. 2,213,477; 2,454,542; 3,004,056; 3,235,627; 4,720,514; 4,872,916; and 5,914,072 all disclose polyalkoxylates containing terminal hydroxyl groups that have been reacted with various phosphorylating agents.

Japanese Patent Publication JP 07185291 A (published Jul. 25, 1995; and assigned to Asahi Denka Kogyo KK) discloses phosphate dispersants suitable for carbon black, and Kerosene in water. The phosphate dispersants are derived from mono-ester phosphites.

International Patent Application WO 06/100244 discloses sulphate or ethyl phosphonate as a dispersing agent for textile dyeing with VAT dyes.

U.S. Pat. No. 4,281,071 discloses the use of an organo-phosphite for viscosity reduction of filled unsaturated polyester resin compositions.

However, it would be advantageous to utilize the dispersant properties of compounds containing terminal acidic groups in both a polar and a non-polar organic medium. Consequently, dispersants are sought which can disperse a particulate solid in both a polar and a non-polar organic medium.

### SUMMARY OF THE INVENTION

In one embodiment, the invention provides a compound of Formula (1) (typically a mono-ester) and salts thereof:

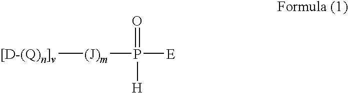

wherein

E is —OH, or an oxygen ion when the compound of Formula (1) is a salt;

Q is a repeat unit derived from an alkoxylate (such as ethoxylate, propoxylate, butoxylate, or mixtures), or an aminocarboxylic acid, or a hydroxycarboxylic acid, or a lactone, a residue of a dicarboxylic acid and diol, or mixtures thereof;

m is 0 or 1, with the proviso that when m is 0, v is 1, and Q is linked via an oxygen from a hydroxy group to P, and via a carboxylic group to D; and when m is 1, v is 1 to 4;

J is a mono-, di-, tri- or poly-hydroxy di-, tri- or poly-carboxylic acid residue, with the proviso that J is linked via a carboxylic group to Q and via a hydroxy group to P when m is 1;

D is a residue of an alcohol, a residue of a thiol, a residue of a carboxylic acid, a residue of an optionally hydrocarbyl-substituted hydroxy-containing aromatic compound, or a residue of an amine (such as a mono-amino residue represented by the general formula R—O—(Y)ₓ-T-N(G)-, or a diamino group represented by the general formula R′-N(G′)-T-O—(Y)ₓ-T-N(G)-) or mixtures thereof;

n is 0 or 100, or 1 to 100, with the proviso that when n is 0, and D is a residue of an alcohol, then the alcohol has a molecular weight of at least 200;

R and R′ are independently H or C₁₋₅₀-optionally substituted hydrocarbyl, or C₁₋₅₀-optionally substituted hydrocarbonyl, or the residue of an epoxide;

Y is an alkyleneoxy group such as C₂₋₄-alkyleneoxy;

T is an alkylene group such as C₂₋₄ alkylene;

G and G′ are independently H or C₁₋₅₀-optionally substituted hydrocarbyl or C₁₋₅₀-optionally substituted hydrocarbonyl; and

x is 2 to 90.

A person skilled in the art will appreciate that the compound of Formula (1), and variants described below, may also be represented by other tautomeric forms of the structures shown.

In one embodiment, the invention provides a composition comprising a particulate solid, an organic or aqueous medium and a compound of Formula (1) and salts thereof as defined above.

In one embodiment, the invention provides a composition comprising a particulate solid, an organic or aqueous medium and a compound obtained/obtainable by reacting:

(a) phosphorous acid;

(b) at least one member of the group consisting of an alkylene oxide, an amino carboxylic acid, a hydroxycarboxylic acid, a lactone, and a mono-, di-, tri- or polyhydroxy di-, tri- or poly-carboxylic acid; and

(c) at least one member of the group consisting of an alcohol, a thiol, a carboxylic acid, and an amine.

In one embodiment, the invention provides a composition comprising a particulate solid, an organic medium and a compound of Formula (1a) and salts thereof:

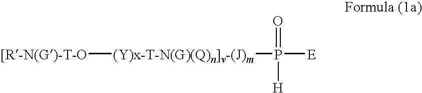

wherein E, R′, T, Y, x, G′, G, B, Q, n, v, J and m are as described above; and wherein G and G′ may be the same or different.

In one embodiment, the invention provides a composition comprising a particulate solid, an organic medium and a compound of Formula (1b) and salts thereof:

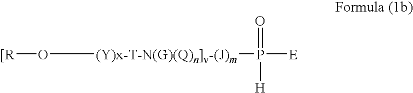

wherein E, R, T, Y, x, G, B, Q, n, v, J and m are as described above.

In one embodiment, the compound of Formula (1) includes a polyether chain, a polyester chain or a mixed polyether-polyester chain, whereby the respective groups can be arranged in blocks or randomly.

In one embodiment, the invention provides for the use of the compound of Formula (1) as a dispersant.

In one embodiment, the invention provides for the use of the compound of Formula (1) as a dispersant in the composition disclosed herein.

### DETAILED DESCRIPTION OF THE INVENTION

The present invention provides a composition as disclosed herein above.

When some or all of R or R′ are hydrocarbyl groups, the number of carbon atoms on each hydrocarbyl group may be in the range of 1 to 36, or from 1 to 20.

In one embodiment, R or R′ are hydrocarbyl groups including aryl, aralkyl, alkaryl, cycloalkyl or alkyl, which may be linear or branched. In one embodiment, the hydrocarbyl group is substituted. In another embodiment, the hydrocarbyl group is unsubstituted.

In one embodiment, R or R′ are aryl. Examples of a suitable aryl group include naphthyl, phenyl, or styrenated phenyl.

In one embodiment, R or R′ are aralkyl. Examples of a suitable aralkyl group include 2-phenylethyl or benzyl.

In one embodiment, R or R′ are alkaryl. Examples of a suitable alkaryl group include octyl phenyl or nonyl phenyl.

In one embodiment, R or R′ are cycloalkyl. Examples of a suitable cycloalkyl group include a C₃₋₈-cycloalkyl, such as, cyclopropyl or cyclohexyl.

R′ may be defined the same or different to R with regard to the number of carbon atoms present on a hydrocarbyl, alkyl group, etc. However, R′ tends not to be the residue of an alcohol.

In one embodiment, at least one of R, R′, G, or G′ includes the residue of an optionally substituted (meth) acrylic ester or amide group, or mixtures thereof. In one embodiment, R′ or R includes the residue of an alkyl (meth)acrylate, or mixtures thereof. In one embodiment, G or G′ includes the residue of an alkyl (meth)acrylate, or mixtures thereof.

As used herein, the term (meth)acryl means acrylic or methacrylic units.

In one embodiment, R is an optionally branched alkyl, such as a C₁₋₃₆ optionally branched alkyl. The group R—O— may thus be the residue of an alcohol such as methanol, ethanol, n-propanol, n-butanol, n-hexanol, n-octanol, n-decanol, n-dodecanol, n-tetradecanol, n-hexadecanol, n-octadecanol, isopropanol, isobutanol, tert-butanol, 2-ethylbutanol, 2-ethylhexanol, 3-heptanol, 3,5,5-trimethylhexanol, 3,7-dimethyloctanol and the so-called Guerbet alcohols such as those which are commercially available under the trade name Isofol (ex Condea GmbH), other branched alcohols commercially available under the trade name Softanol (ex Nippon Shokubai), or mixtures thereof. Specific examples of Guerbet alcohols are Isofol 12, 14E, 14T, 16, 18T, 18E, 20, 24, 28, 32, 32T and 36.

R in other embodiments may be C₁₋₆-alkyl, C₁₋₄-alkyl, or methyl.

When R is substituted hydrocarbyl, the substituent may be C₁₋₁₀-alkoxy, acyl, sulphonyl, carbamoyl, sulphamoyl, halogen, nitrile, ureido-containing group, urethane-containing group, ester (i.e., R—COO— or R—OCO—), or aryl group.

When a portion of Y is C₃₋₄-alkyleneoxy, and the chain represented by (Y)ₓ contains ethyleneoxy (—CH₂CH₂O—), the structure of (Y)ₓ may be random or block. In one embodiment, structure of (Y)ₓ is block.

The chain represented by (Y)ₓ may contain only one type of C₃₋₄-alkyleneoxy repeat unit or it may contain two or more different C₃₋₄-alkyleneoxy repeat units. When the chain represented by (Y)ₓ contains two or more different C₃₋₄-alkyleneoxy repeat units, the structure of (Y)ₓ may be random or block.

In one embodiment, Y is a C₃₋₄-alkyleneoxy group, —CH₂CH₂CH₂CH₂O— or —CH₂CH(CH₃)CH₂O— or —CH₂CH(CH₃)O—. In another embodiment, Y is a —CH₂CH₂CH(CH₃)O— or —CH₂—CH(CH₂—CH₃)—O—. In one embodiment, Y is C₃₋₄-alkyleneoxy and the chain represented by (Y)ₓ is —CH₂CH₂CH₂CH₂O—, —CH₂CH(CH₃)O— or —CH₂—CH(CH₂—CH₃)—O—.

In one embodiment, the dispersant of Formula (1) includes C₃₋₄-alkyleneoxy (e.g., —CH₃CH(CH₃)O—) and may contain a portion of ethyleneoxy repeat units. The ethyleneoxy repeat units in different embodiments may be present on the chain represented by (Y)ₓ up to a maximum of 45 wt % of the chain, or up to 35 wt. % of the chain, or up to 30 wt. % of the chain. In one embodiment, no ethyleneoxy repeat units are present on (Y)ₓ.

In other embodiments, the chain (Y)ₓ, may contain at least 50 wt. %, or at least 75 wt. % of ethyleneoxy repeat units when the compound is required for an aqueous medium, optionally further including polar organic liquids. In one embodiment, no propyleneoxy repeat units are present on (Y)ₓ.

In one embodiment, the compound of Formula (1) includes a Y group containing —CH₂CH(CH₃)O— and the chain represented by (Y)ₓ may contain up to 45% ethyleneoxy repeat units.

In one embodiment, the dispersant of Formula (1) includes a Y group of —CH₃CH(CH₃)O— and the chain represented by (Y)ₓ may contain up to 90% ethyleneoxy repeat units.

In one embodiment, Y is a mixture of C₃₋₄-alkyleneoxy where the chain represented by (Y)ₓ is in part —CH₂CH₂CH₂CH₂O—, —CH₂CH(CH₃)O— or —CH₂—CH(CH₂—CH₃)—O—, with up to 90% ethyleneoxy groups present.

In one embodiment, the compound of Formula (1) contains a Y group of only ethyleneoxy repeat units and these may be used in an aqueous medium.

In different embodiments, T includes C₃₋₄-alkylene groups, or —CH₂CH(CH₃)— groups, or —CH₂CH₂CH₂— groups. In one embodiment, T includes —CH₂CH(CH₃)—. In one embodiment, T includes —CH₂CH(CH₃)—; and Y includes —CH₂CH(CH₃)O—.

In one embodiment, the Formula (1a) is derivable from the residue of the group R′-N(G′)-T-O—(Y)ₓ-T-NG. The R′-N(G′)-T-O—(Y)ₓ-T-NG- is typically the residue of a polyalkyleneoxide diamine. Compounds of this type are commercially available as the Jeffamine™ D or ED-series of diamines from Huntsman Corporation. Specific examples of Jeffamine™ diamines are D-230 (3,0,230), D-400 (6,0,400), D-2000 (33,0,2000), D-4000 (68,0,4000), ED-600 (3.6,9,600), ED-900 (2.5,15.5,900) and ED2003 (6,39,2000). The figures in parentheses are approximate repeat units of propylene oxide, ethylene oxide and number-average molecular weight, respectively.

In one embodiment, the Formula (1b) is derivable from the residue of the group RO—(Y)_{X}-T-NG-. The group RO—(Y)ₓ-T-NG-typically is the residue of a polyalkyleneoxide monoalkyl ether monoamine. Compounds of this type are commercially available as the Jeffamine™ M-series of monoamines or Surfonamine™ amines, from Huntsman Corporation. Specific examples of Jeffamine™ amines include M-600 (9,0,600), M-1000 (3,18,1000), M-2005 (32,2,2000), M-2070 (10, 31, 2000) and XTJ-234 (8,49,3000). Specific examples of Surfonamine™ amines include B-60 (9,1,600), B-100, B-200 (29,6,2000), L-100 (3,19,1000), L-200 (4,41,2000), L-207 (10,33,2000), and L-300 (8,58,3000). The figures in parentheses are approximate repeat units of propylene oxide, ethylene oxide and number-average molecular weight, respectively.

In one embodiment, D is a hydrocarbyl group that may be defined in a similar way to R and R′ above. For instance, D may contain 1 to 36, or 1 to 20 carbon atoms.

In one embodiment, D of formula (1) is the residue of an alcohol, n typically ranges from 1 to 100. Examples of a suitable alcohol include methanol, ethanol, n-propanol, n-butanol, n-hexanol, n-octanol, n-decanol, n-dodecanol, n-tetradecanol, n-hexadecanol, n-octadecanol, isopropanol, isobutanol, tert-butanol, 2-ethylbutanol, 2-ethylhexanol, 3-heptanol, 3,5,5-trimethylhexanol, 3,7-dimethyloctanol and the so-called Guerbet alcohols discussed above.

In one embodiment, D is a residue of a substituted alcohol. The substituted alcohol may contain a C₁₋₁₀-alkoxy, carbonyl, sulphonyl, carbamoyl, sulphamoyl, halogen, nitrile, ureido, urethane, ester (i.e., —COO— or —OCO—), or aryl group.

When D of Formula (1) is a residue of an alcohol, and n is 0, a suitable alcohol has a molecular weight of at least 200, or at least 250, or at least 300. The maximum molecular weight of the alcohol may be 10,000, or 5000, or 3000. In one embodiment, the alcohol may have a molecular weight of 225 to 8000, or 500 to 2500.

In one embodiment, D includes the residue of a hydrocarbyl-substituted hydroxy-containing aromatic compound such as an alkylphenol, a styrenated-phenol or styrenated alkylphenol.

In one embodiment, D includes the residue of a styrenated-phenol, and Q includes the residue of a polyether derived from ethylene oxide and propylene oxide, such as those disclosed in U.S. Pat. Nos. 5,464,895 and 5,412,139.

In one embodiment, Q includes a residue of an amino carboxylic acid, or mixtures thereof. The amino carboxylic acid includes amino-C₂₋₂₀-alkenylene carboxylic acid or amino-C₁₋₂₀-alkylene carboxylic acid. The alk(en)ylene group may be linear or branched. In one embodiment, the alk(en)ylene group of the amino carboxylic acid contains not greater than 12 carbon atoms. Specific examples include glycine, 11-amino undecanoic acid, 6-amino caproic acid, 4-aminobutyric acid, β-alanine and sarcosine. Mixtures of amino carboxylic acids may be used.

In one embodiment, Q is a repeat unit derived from a hydroxycarboxylic acid, or a lactone, or mixtures thereof.

Examples of a suitable hydroxycarboxylic acid or lactone thereof include lactic acid, glycolic acid, 6-hydroxyhexanoic acid, 12-hydroxystearic acid, ricinoleic acid, 12-hydroxydodecanoic acid, 5-hydroxydodecanoic acid, 5-hydroxydecanoic acid, 4-hydroxydecanoic acid, or lactones. Lactones include γ-propiolactone, γ-butyrolactone, an optionally-substituted δ-valerolactone, an optionally-substituted ε-caprolactone, a block copolymer of (ε-caprolactone and δ-valerolactone), or mixtures thereof.

In one embodiment, Q is a repeat unit derived from an alkoxylate, or a hydroxycarboxylic acid, or a lactone, or mixtures thereof, which is linked via an oxygen of a hydroxy group to P, and via a carboxylic group to D, or mixtures thereof.

In one embodiment, Q is derived from units linking a dicarboxylic acid to a diol. Suitable examples of a dicarboxylic acid include oxalic acid, malonic acid, succinic acid, glutaric acid, adipic acid, azelaic acid, sebacic acid, maleic acid, fumaric acid, citraconic acid, itaconic acid, cyclohexanedicarboxylic acid, phthalic acid, diglycolic acid; or anhydrides thereof, or mixtures thereof. Examples of suitable diols include butane-1,4-diol, pentane-1,5-diol, hexane-1,6-diol, ethylene glycol, propylene glycol, butylene glycol, pentylene glycol, hexylene glycol, 1,4-cyclohexanedimethanol, neopentyl glycol, thiodiglycol, oligo-alkyleneglycols, polyalkyleneglycols, or mixtures thereof.

As used herein, the terms “poly-hydroxy” or “poly carboxylic acid” means a compound that contains four or more hydroxy or carboxylic acid groups.

In one embodiment, J is a mono-, di-, tri- or poly-hydroxy di-, tri- or poly-carboxylic acid residue which is linked via an oxygen of a hydroxy group to P, and via a carboxylic group to D-Q, or mixtures thereof.

Examples of a suitable mono-, di-, tri- or poly-hydroxy di-, tri- or poly-carboxylic acid include tartaric acid, malic acid, citramalic acid (2-methylmalic acid), 3-hydroxy-3-methylglutaric acid, 5-hydroxyisophthalic acid, ascorbic acid or citric acid, or mixtures thereof. In one embodiment, the polycarboxylic acid includes malic acid (hydroxybutane dicarboxylic acid), citric acid, or mixtures thereof.

An example of a suitable poly-carboxylic acid includes hydroxy-benzene-1,2,4,5-tetracarboxylic acid.

In one embodiment, Q includes a polyether chain (such as mixtures of ethylene oxide, propylene oxide and butylene oxide), whereby the respective groups may be arranged in blocks or randomly.

In one embodiment, D-Q includes a polyC₂₋₄ alkyleneglycolmonoether and/or a polyC₂₋₄ alkylene glycol monoester of a carboxylic acid.

Examples of suitable polyC₂₋₄ alkyleneglycolmonoethers include C₁₋₂₀ alkylethers. Alkylethers include methylethers (MePEG), (MePPG), butylethers (BuPPG), alkylphenol ethers (APE), alkyl phenol alkoxylates (such as nonyl phenol ethoxylate), C₁₂₋₂₀ fatty alcohol ethers. C₁₀₋₁₅ oxoalcohol ethers, or mixtures thereof.

Examples of polyC₂₋₄ alkylene glycol esters of carboxylic acids include polyC₂₋₄ alkylene glycol monolaurate, polyC₂₋₄ alkylene glycol monostearate, polyC₂₋₄ alkylene glycol monooleate, polyC₂₋₄ alkylene glycol benzoate, or mixtures thereof.

In one embodiment, the polyC₂₋₄ alkyleneglycolmonoether and/or a polyC₂₋₄ alkylene glycol monoester of a carboxylic acid may be esterified with a di-, tri- or poly-carboxylic acid or may be linked to a di-, tri- or poly-carboxylic acid, via polyester units derived from a hydroxy-carboxylic acid or a lactone thereof, and/or via units derived from a dicarboxylic acid which is linked to a diol with a C₂₋₄ alkylene oxide structure. A more detailed description of the resultant polyC₂₋₄ alkyleneglycolmonoether and/or a polyC₂₋₄ alkylene glycol monoester of a carboxylic acid is described in International Publication WO 05/085261, page 3, line 30 to page 4, line 22.

In one embodiment, the group [D-(Q)ₙ]ᵥ-(J)ₘ- of Formula (1) has a number average molecular weight of 200 to 10,000, or 200 to 5000, or 300 to 3000.

Salts of Formula (1) may be derived from an alkali metal (such as sodium or potassium), an alkaline earth metal (such as calcium or magnesium), a transition metal (such as zinc, copper, or nickel), ammonia, an amine (such as butyl amine), an alkanolamine (such as diethanolamine), or quaternary ammonium salt.

In one embodiment, the compound of Formula (1) defines:

(i) D as a residue of an alcohol, a residue of a thiol, a residue of a carboxylic acid, a residue of a optionally hydrocarbyl-substituted hydroxy-containing aromatic compound, and a residue of amine; and

(ii) Q has the general Formula (2)-[AO]ⱼ[BU]ₖ-,

wherein

the sum of j and k is 1 to 100.

AO represents the residue of an alkylene oxide including an oxyethylene group, a oxypropylene group, a oxybutylene group, or mixtures thereof; and

BU represents the residue of an amino carboxylic acid, a mono-hydroxy carboxylic acid (including 12-hydroxystearic acid, or ricinoleic acid) or a lactone (including γ-propiolactone, γ-butyrolactone, δ-valerolactone, optionally-substituted ε-caprolactone, a block copolymer of (ε-caprolactone and δ-valerolactone)), a residue of a dicarboxylic acid and diol, or mixtures thereof.

Mixtures of the alkylene oxide include ethylene oxide and propylene oxide.

In one embodiment, the invention provides a process to prepare the compound of Formula (1), or a compound obtained/obtainable by reacting

(a) phosphorous acid, or mixtures thereof;

(b) at least one member of the group consisting of an alkylene oxide, an amino carboxylic acid, a hydroxycarboxylic acid, a lactone, and a mono-, di-, tri- or polyhydroxy di-, tri- or poly-carboxylic acid; and

(c) at least one member of the group consisting of an alcohol, a thiol, a carboxylic acid, and an amine.

Typically, the process comprises reacting (b) and (c). The product of (b) and (c) is then reacted with phosphorous acid.

Any of the reactive agents of (b) may be in the form of a pre-polymer. The pre-polymer may also be used as alternatives to any of reactants in (b). Optionally, and of the reactants of (b), may contain groups derived from (c).

The reaction of a lactone with an alcohol may be carried out in an inert atmosphere (such as nitrogen or argon), at a temperature in the range of 150° C. to 180° C., and optionally in the presence of an esterification catalyst. Examples of a suitable esterification catalyst include tetra-alkyl titanate, for example, tetrabutyl titanate, zinc salt of an organic acid, for example, zinc acetate, zirconium salt of an aliphatic alcohol, for example, zirconium isopropoxide, toluene sulphonic acid or a strong organic acid such as haloacetic acid, for example, trifluoroacetic acid. In one embodiment, the esterification catalyst is zirconium isopropoxide.

The reaction of (b) and (c), when (b) includes a hydroxycarboxylic acid may be carried out at a reaction temperature of 100° C. to 250° C., optionally in the presence of an esterification catalyst. Suitable esterification catalysts include dibutyl tin dilaurate, tetraalkyltitanate, p-toluene sulphonic acid or ferrous acetylacetonate.

The reaction with phosphorous acid may be carried out at 50° C. to 150° C., for a period of 1 hour to 24 hours. The reaction is optionally carried out in the presence of an inert solvent, such as xylene or toluene, and optionally in the presence of a catalyst. In one embodiment, no catalyst is necessary.

### INDUSTRIAL APPLICATION

In one embodiment, the compound of Formula (1) is a dispersant.

The compound of Formula (1) in different embodiments is present in the composition of the invention in a range selected from 0.1 to 50 w. %, or 0.25 to 35 wt. %, and 0.5 to 30 wt. %.

The particulate solid present in the composition may be any inorganic or organic solid material which is substantially insoluble in the organic medium. In one embodiment, the particulate solid is a pigment.

In one embodiment, the composition of the invention provides a paint or ink including a particulate solid, an organic liquid, a binder and a compound of Formula (1), or salts thereof.

In one embodiment, the solid is an organic pigment from any of the recognised classes of pigments described, for example, in the Third Edition of the Colour Index (1971) and subsequent revisions of, and supplements thereto, under the chapter headed “Pigments”. Carbon black, although strictly inorganic, behaves more like an organic pigment in its dispersing properties.

Examples of suitable solids are pigments for solvent inks; pigments, extenders and fillers for paints and plastics materials; disperse dyes; optical brightening agents and textile auxiliaries for solvent dyebaths, inks and other solvent application systems; solids for oil-based and inverse-emulsion drilling muds; dirt and solid particles in dry cleaning fluids, biocides, agrochemicals and pharmaceuticals which are applied as dispersions in organic solids; particulate ceramic materials; magnetic materials and magnetic recording media; fibres such as glass, steel, carbon and boron for composite materials.

Inorganic solids include: extenders and fillers such as talc, kaolin, silica, barytes and chalk, flame-retardant fillers such as alumina trihydrate, or magnesium hydroxide; particulate ceramic materials such as alumina, silica, zirconia, titania, silicon nitride, boron nitride, silicon carbide, boron carbide, mixed silicon-aluminum nitrides and metal titanates; particulate magnetic materials such as the magnetic oxides of transition metals, especially iron and chromium, e.g., gamma-Fe₂O₃, Fe₃O₄, and cobalt-doped iron oxides, calcium oxide, ferrites, especially barium ferrites; and metal particles, especially metallic iron, nickel, cobalt, copper and alloys thereof.

The organic medium present in the composition of the invention in one embodiment is a plastics material and in another embodiment an organic liquid. The organic liquid may be a non-polar or a polar organic liquid, although a polar organic liquid is typically used. By the term “polar” in relation to the organic liquid, it is meant that an organic liquid is capable of forming moderate to strong bonds as described in the article entitled “A Three Dimensional Approach to Solubility” by Crowley et al. in Journal of Paint Technology, Vol. 38, 1966, at page 269. Such organic liquids generally have a hydrogen bonding number of 5 or more as defined in the abovementioned article.

Examples of suitable polar organic liquids are amines, ethers, especially lower alkyl ethers, organic acids, esters, ketones, glycols, alcohols and amides. Numerous specific examples of such moderately strongly hydrogen bonding liquids are given in the book entitled “Compatibility and Solubility” by Ibert Mellan (published in 1968 by Noyes Development Corporation) in Table 2.14 on pages 39-40, and these liquids all fall within the scope of the term polar organic liquid as used herein.

In one embodiment, polar organic liquids include dialkyl ketones, alkyl esters of alkane carboxylic acids and alkanols, especially such liquids containing up to, and including, a total of 6 or 8 carbon atoms. As examples of the polar organic liquids include dialkyl and cycloalkyl ketones, such as acetone, methyl ethyl ketone, diethyl ketone, di-isopropyl ketone, methyl isobutyl ketone, di-isobutyl ketone, methyl isoamyl ketone, methyl n-amyl ketone and cyclohexanone; alkyl esters such as methyl acetate, ethyl acetate, isopropyl acetate, butyl acetate, ethyl formate, methyl propionate, methoxy propylacetate and ethyl butyrate; glycols and glycol esters and ethers, such as ethylene glycol, 2-ethoxyethanol, 3-methoxypropylpropanol, 3-ethoxypropylpropanol, 2-butoxyethyl acetate, 3-methoxypropyl acetate, 3-ethoxypropyl acetate and 2-ethoxyethyl acetate; alkanols such as methanol, ethanol, n-propanol, isopropanol, n-butanol and isobutanol and dialkyl and cyclic ethers such as diethyl ether and tetrahydrofuran. In one embodiment solvents are alkanols, alkane carboxylic acids and esters of alkane carboxylic acids.

Examples of organic liquids, which may be used as polar organic liquids are film-forming resins such as inks, paints and chips for use in various applications such as paints and inks. Examples of such resins include polyamides, such as Versamid™ and Wolfamid™, and cellulose ethers, such as ethyl cellulose and ethyl hydroxyethyl cellulose, nitrocellulose and cellulose acetate butyrate resins, including mixtures thereof. Examples of paint resins include short oil alkyd/melamine-formaldehyde, polyester/melamine-formaldehyde, thermosetting acrylic/melamine-formaldehyde, long oil alkyd, polyether polyols and multi-media resins such as acrylic and urea/aldehyde.

The organic liquid may be a polyol, that is to say, an organic liquid with two or more hydroxy groups. In one embodiment, polyols include alpha-omega diols or alpha-omega diol ethoxylates.

In one embodiment, non-polar organic liquids are compounds containing aliphatic groups, aromatic groups or mixtures thereof. The non-polar organic liquids include non-halogenated aromatic hydrocarbons (e.g., toluene and xylene), halogenated aromatic hydrocarbons (e.g., chlorobenzene, dichlorobenzene, chlorotoluene), non-halogenated aliphatic hydrocarbons (e.g., linear and branched aliphatic hydrocarbons containing six or more carbon atoms both fully and partially saturated), halogenated aliphatic hydrocarbons (e.g., dichloromethane, carbon tetrachloride, chloroform, trichloroethane) and natural non-polar organics (e.g., vegetable oil, sunflower oil, linseed oil, terpenes and glycerides).

In one embodiment, the organic liquid includes at least 0.1% by weight, or 1% by weight or more of a polar organic liquid based on the total organic liquid.

The organic liquid optionally further includes water. In one embodiment, the organic liquid is free of water.

When the organic liquid contains water, the amount present in one embodiment is not greater than 70%, or not greater than 50%, or not greater than 40% by weight based on the amount of organic liquid.

The plastics material may be a thermoset resin or a thermoplastic resin. The thermosetting resins useful in this invention include resins which undergo a chemical reaction when heated, catalysed, or subject to UV or electron beam radiation and become relatively infusible. Typical reactions in thermosetting resins include oxidation of unsaturated double bonds, reactions involving epoxy/amine, epoxy/carbonyl, epoxy/hydroxyl, polyisocyanate/hydroxy, amino resin/hydroxy moieties, free radical reactions or polyacrylate, cationic polymerization or epoxy resins and vinyl ether, or condensation of silanol.

Polymers with hydroxy functionality (frequently polyols) are widely used in thermosetting system to crosslink with amino resins or polyisocyanates. The polyols include acrylic polyols, alkyd polyols, polyester polyols, polyether polyols and polyurethane polyols. Typical amino resins include melamine formaldehyde resins, benzoguanamine formaldehyde resins, urea formaldehyde resins and glycoluryl formaldehyde resins. Polyisocyanates are resins with two or more isocyanate groups, including both monomeric aliphatic diisocyanates, monomeric aromatic diisocyanates; and their polymers. Typical aliphatic diisocyanates include hexamethylene diisocyanate, isophorone diisocyanate and hydrogenated diphenylmethane diisocyanate. Typical aromatic isocyanates include toluene diisocyanates and diphenylmethane diisocyanates.

In one embodiment, thermoplastic resins include polyolefins, polyesters, polyamides, polycarbonates, polyurethanes, polystyrenics, poly(meth)acrylates, celluloses and cellulose derivatives. Said compositions may be prepared in a number of ways but melt mixing and dry solid blending are typical methods.

If desired, the compositions may contain other ingredients, for example, resins (where these do not already constitute the organic medium), binders, fluidizing agents, anti-sedimentation agents, plasticizers, surfactants, anti-foamers, rheology modifiers, levelling agents, gloss modifiers and preservatives.

The compositions typically contain from 1 to 95% by weight of the particulate solid, the precise quantity depending on the nature of the solid and the quantity depending on the nature of the solid and the relative densities of the solid and the polar organic liquid. For example, a composition in which the solid is an organic material, such as an organic pigment, in one embodiment contains from 15 to 60% by weight of the solid whereas a composition in which the solid is an inorganic material, such as an inorganic pigment, filler or extender, in one embodiment contains from 40 to 90% by weight of the solid based on the total weight of composition.

The composition may be prepared by any of the conventional methods known for preparing dispersions. Thus, the solid, the organic medium and the dispersant may be mixed in any order, the mixture then being subjected to a mechanical treatment to reduce the particles of the solid to an appropriate size, for example, by ball milling, bead milling, gravel milling or plastic milling until the dispersion is formed. Alternatively, the solid may be treated to reduce its particle size independently or in admixture with either, the organic medium or the dispersant, the other ingredient or ingredients then being added and the mixture being agitated to provide the composition.

In one embodiment, the composition of the present invention is suited to liquid dispersions. In one embodiment, such dispersion compositions comprise: (a) 0.5 to 40 parts of a particulate solid, (b) 0.5 to 30 parts of a compound of Formula (1), and (c) 30 to 99 parts of an organic or aqueous medium; wherein all parts are by weight and the amounts (a)+(b)+(c)=100.

In one embodiment, component a) includes 0.5 to 40 parts of a pigment and such dispersions are useful as liquid inks, paints and mill-bases.

If a composition is required including a particulate solid and a compound of Formula (1) in dry form, the organic liquid is typically volatile so that it may be readily removed from the particulate solid by a simple separation means such as evaporation. In one embodiment, the composition includes the organic liquid.

If the dry composition consists essentially of the compound of Formula (1) and the particulate solid, it typically contains at least 0.2%, at least 0.5% or at least 1.0% the compound of Formula (1) based on weight of the particulate solid. In one embodiment, the dry composition contains not greater than 100%, not greater than 50%, not greater than 20%, or not greater than 10% by weight of the compound of Formula (1) based on the weight of the particulate solid. In one embodiment, the compound of Formula (1) is present at 0.6 wt. % to 8 wt. %.

As disclosed hereinbefore, the compositions of the invention are suitable for preparing mill-bases wherein the particulate solid is milled in an organic liquid in the presence of a compound of Formula (1), or salts thereof.

Thus, according to a still further embodiment of the invention, there is provided a mill-base including a particulate solid, an organic liquid and a compound of Formula (1), or salts thereof.

Typically, the mill-base contains from 20 to 70% by weight particulate solid based on the total weight of the mill-base. In one embodiment, the particulate solid is not less than 10 or not less than 20% by weight of the mill-base. Such mill-bases may optionally contain a binder added either before or after milling. The binder is a polymeric material capable of binding the composition on volatilization of the organic liquid.

Binders are polymeric materials including natural and synthetic materials. In one embodiment, binders include poly(meth)acrylates, polystyrenics, polyesters, polyurethanes, alkyds, polysaccharides such as cellulose, and natural proteins such as casein. In one embodiment, the binder is present in the composition at more than 100% based on the amount of particulate solid, more than 200%, more than 300% or more than 400%.

The amount of optional binder in the mill-base can vary over wide limits but is typically not less than 10%, and often not less than 20% by weight of the continuous/liquid phase of the mill-base. In one embodiment, the amount of binder is not greater than 50% or not greater than 40% by weight of the continuous/liquid phase of the mill-base.

The amount of dispersant in the mill-base is dependent on the amount of particulate solid but is typically from 0.5 to 5% by weight of the mill-base.

Dispersions and mill-bases made from the composition of the invention are particularly suitable for use in coatings and paints both solvent-based and water-base, especially high solids paints; inks, especially offset, flexographic, gravure, radiation-curable, and screen inks; non-aqueous ceramic processes, especially tape-coating, doctor-blade, extrusion and injection moulding type processes, composites, cosmetics, adhesives and plastics materials.

In one embodiment, the composition of the invention further includes one or more additional known dispersants.

The following examples provide illustrations of the invention. These examples are non exhaustive and are not intended to limit the scope of the invention. All chemicals were purchased from Aldrich except where stated.

### EXAMPLES

Intermediate 1: A vessel is charged with dodecanol (18.7 parts), ε-caprolactone (110 parts), δ-valerolactone (34.2 parts) are stirred at 150° C. under a nitrogen atmosphere. The vessel is charged with tetra-butyl zirconate (or zirconium 4-butoxide) (0.5 parts). The whole mixture is then stirred at 175° C. for 6 hours to give a clear viscous liquid which cooled to a white wax (160 parts).

Intermediate 2: A pressure vessel is charged with polyethyleneglycol monomethyl ether (MW 550, Ex Fluka, 110.9 parts) and sodium hydroxide pellets (1 part). The vessel is pressurized to 10 psi (about 69 kPa) with nitrogen and heated to 155° C. Propylene oxide (35 parts) is then charged to the vessel and allowed to react, until the pressure decreases to 10 psi (about 69 kPa). The product is pale yellow oil (145.57 parts).

Intermediate 3A: A pressure vessel is charged with polyethyleneglycol monomethylether (Mn350, 351.9 parts) and potassium hydroxide (1 part). The vessel is pressurised with nitrogen to 10 psi and the contents are heated, with stirring, to 110° C. Propylene oxide (175.2 parts) is added and allowed to react until the pressure is stable at 18 psi. The product is a pale yellow liquid (528 parts).

Intermediate 3: A pressure vessel is charged with Intermediate 3A (238 parts) and potassium hydroxide (0.5 parts). The vessel is pressurised with nitrogen to 10 psi and the contents are heated, with stirring, to 155° C. Ethylene oxide (100 parts) is added and allowed to react until the pressure is stable at 14 psi. The product is a golden liquid (339 parts).

Intermediate 4A: A pressure vessel is charged with Intermediate 3A (290.7 parts). The vessel is pressurised with nitrogen to 10 psi and the contents are heated, with stirring, to 110° C. Propylene oxide (64.42 parts) is added and allowed to react until the pressure is stable at 18 psi. The product is a pale yellow liquid (354 parts).

Intermediate 4: A pressure vessel is charged with Intermediate 4A (290.8 parts) and potassium hydroxide (0.5 parts). The vessel is pressurised with nitrogen to 10 psi and the contents are heated, with stirring, to 155° C. Ethylene oxide (100 parts) is added and allowed to react until the pressure is stable at 14 psi. The product is a hazy yellow liquid (391 parts).

Intermediate 5: A pressure vessel is charged with polypropyleneglycol monobutylether (Mn340, 193.1 parts) and potassium hydroxide (1 part). The vessel is pressurised with nitrogen to 10 psi and the contents are heated, with stirring, to 155° C. Ethylene oxide (200.1 parts) is added and allowed to react until the pressure is stable at 16 psi. The product is a beige solid (396 parts).

Intermediate 6: A pressure vessel is charged with polypropyleneglycol monobutylether (Mn340, 140.7 parts) and potassium hydroxide (1 part). The vessel is pressurised with nitrogen to 10 psi and the contents are heated, with stirring, to 155° C. Ethylene oxide (200.56 parts) is added and allowed to react until the pressure is stable at 14 psi. The product and magnesium silicate (25 parts) are stirred at 120° C. under nitrogen for 4 hours before filtering through diatomaceous earth. The product is a pale yellow solid (224 parts).

Intermediate 7: A vessel is charged with polyethyleneglycol monomethylether (Mn350, 250.4 parts), ε-caprolactone (157.35 parts), δ-valerolactone (92.26 parts) and dodecylbenzenesulfonic acid (0.75 parts). The mixture is stirred at 150° C. under nitrogen for 6 hours. The product is a pale yellow liquid (494 parts).

Intermediate 8: A vessel is charged with 7-methylcaprolactone (22.47 parts), (an amber liquid prepared using the method described for Lactone 3 in International Patent WO 98/19784), ε-caprolactone (29.95 parts), polyethyleneglycol monomethylether (Mn350, 47.58 parts) and dodecylbenzenesulfonic acid (0.15 parts). The mixture is stirred at 180° C. under nitrogen for 6 hours. The product is an amber liquid (89.84 parts).

Intermediate 9: A vessel is charged with polyethyleneglycol monomethylether (Mn350, 289.75 parts), ε-caprolactone (210.25 parts) and p-toluenesulfonic acid (0.73 parts). The mixture is stirred at 150° C. under nitrogen for 6 hours. The product is a hazy, pale yellow liquid (495 parts).

Intermediate 10: A vessel is charged with polyethyleneglycol monomethylether (Mn350, 70.67 parts), ε-caprolactone (29.33 parts) and dodecylbenzenesulfonic acid (0.15 parts). The mixture is stirred at 180° C. under nitrogen for 6 hours. The product is a yellow liquid (96.19 parts).

Intermediate 11: A vessel is charged with polyethyleneglycol monomethylether (Mn350, 76.26 parts), ε-caprolactone (23.74 parts) and dodecylbenzenesulfonic acid (0.15 parts). The mixture is stirred at 180° C. under nitrogen for 6 hours. The product is an amber liquid (93.54 parts).

Intermediate 12: A vessel is charged with polyethyleneglycol monomethylether (Mn350, 82.81 parts), ε-caprolactone (17.19 parts) and dodecylbenzenesulfonic acid (0.15 parts). The mixture is stirred at 180° C. under nitrogen for 6 hours. The product is a yellow liquid (96.99 parts).

Intermediate 13: A vessel is charged with Jeffamine M600 (83.9 parts), ε-caprolactone (16.1 parts) and acidic zirconium cation exchanged montmorillonite (1 part), (prepared by the method given for zinc montmorillonite in Bull. Chem. Soc. Jpn., 66, 2016-2032 (1993)). The suspension is stirred at 180° C. under nitrogen for 6 hours. The crude product is filtered through Diatomaceous earth. The product is a brown liquid (74.31 parts, Base Equivalence was measured as 10170).

Intermediate 14: A vessel is charged with Jeffamine M600 (72.24 parts), ε-caprolactone (27.76 parts) and acidic zirconium cation exchanged montmorillonite (1 part). The suspension is stirred at 180° C. under nitrogen for 6 hours. The crude product is filtered through diatomaceous earth. The product is a brown liquid (66.33 parts, Base Equivalence 51030 mg).

Intermediate 15: A vessel is charged with polyethyleneglycol monomethyl ether monoaminopropyl ether (Mn 600, 97.25 parts) and ε-caprolactone (36.27 parts). The mixture is stirred at 150° C. under nitrogen for 6 hours. The product is a dark brown liquid (133.9 parts, Base Equivalence was measured as 35800).

Intermediate 16: A vessel is charged with polyethyleneglycol monomethylether (Mn350, 46.5 parts) and ε-caprolactone (30.34 parts). The mixture is heated to 180° C., with stirring, under a nitrogen blanket. After addition of dibutyltin dilaurate (0.1 parts), the mixture is stirred at 180° C. under nitrogen for 6 hours. The temperature is dropped to 140° C. and citric acid (25.54 parts) is charged to the vessel. The mixture is stirred at 180° C. for a further 3 hours. The product is a brown, viscous liquid (91.90 parts, Acid Value measured 116.9 mg KOH/g).

Intermediate 17: A vessel is charged with polyethyleneglycol monomethylether (Mn350, 189.70 parts) and ε-caprolactone (247.4 parts). The mixture is heated to 180° C., with stirring, under a nitrogen blanket. After addition of dibutyltin dilaurate (0.5 parts), the mixture is stirred at 180° C. under nitrogen for 6 hours. The temperature is dropped to 140° C. and malic acid (72.66 parts) is charged to the vessel. The mixture is stirred at 180° C. for a further 20 hours. The product is a brown, hazy liquid (472.80 parts, Acid Value measured 47.7 mg KOH/g).

Intermediate 18A: A vessel is charged with Jeffamine M600 (ex Huntsman) (209.7 parts), ε-caprolactone (40.29 parts) and acidic zirconium cation exchanged montmorillonite (2.5 parts). The suspension is stirred at 150° C. under nitrogen for 12 hours. The crude product is filtered through Diatomaceous earth. The product is a brown liquid (138.35 parts, Base Equivalence measured as 5020 mg).

Intermediate 18: A vessel is charged with Intermediate 18A (72.25 parts), malic acid (13.68 parts) and dodecylbenzenesulfonic acid (0.15 parts). The mixture is stirred at 180° C. under nitrogen for 3 hours. The product is a dark brown liquid (80.16 parts, Acid value measured 52.95 mg KOH/g).

Intermediate 19: A vessel is charged with Intermediate 18A (66.10 parts), citric acid (19.61 parts) and dodecylbenzenesulfonic acid (0.15 parts). The mixture is stirred at 180° C. under nitrogen for 2 hours. The product is a dark brown liquid (78.09 parts, Acid value 73.86 mg).

Intermediate 20: A vessel is charged with Jeffamine M600 (75.56 parts) and citric acid (26.73 parts). The mixture is stirred at 150° C. under nitrogen for 3 hours. The product is a dark brown liquid (93.3 parts, Base Equivalence measured 87.19).

Intermediate 21: A vessel is charged with polyethyleneglycol monomethylether (Mn350, 35 parts), ε-caprolactone (20.54 parts) and γ-aminobutyric acid (18.56 parts). The mixture is stirred at 190° C. under nitrogen for 22 minutes. The temperature is lowered to 135° C. and zirconium (IV) butoxide solution (80% w/w in tert-butanol, 0.3 parts) is charged the vessel. The mixture is stirred at 190° C. for a further 6 hours. The product is a light brown liquid (65 parts, Acid Value 1.82 mg KOH/g).

Intermediate 22: A vessel is charged with polyethyleneglycol monomethylether (Mn350, 49.58 parts), ε-caprolactone (32.34 parts) and γ-aminobutyric acid (21.91 parts). The mixture is stirred at 190° C. under nitrogen for 20 minutes. The temperature is lowered to 150° C. and zirconium (IV) butoxide solution (80% w/w in tert-butanol, 0.25 parts) is charged the vessel. The mixture is stirred at 190° C. for a further 6 hours. The product is a dark brown liquid (87.49 parts, Acid Value 1.80 mg KOH/g).

Intermediate 23: A vessel is charged with polyethyleneglycol monomethylether (Mn350, 46.10 parts), ε-caprolactone (27.06 parts) and 6-aminocaproic acid (31.10 parts). The mixture is stirred at 190° C. under nitrogen for 18 minutes. The temperature is lowered to 150° C. and zirconium (IV) butoxide solution (80% w/w in tert-butanol, 0.25 parts) is charged the vessel. The mixture is stirred at 190° C. for a further 6 hours. The product is a brown solid (83.32 parts, Acid Value 2.22 mg KOH/g).

Intermediate 24: A vessel is charged with polyethyleneglycol monomethylether (Mn350, 46.10 parts), ε-caprolactone (30.07 parts) and 6-aminocaproic acid (25.92 parts). The mixture is stirred at 190° C. under nitrogen for 20 minutes. The temperature is lowered to 150° C. and zirconium (IV) butoxide solution (80% w/w in tert-butanol, 0.25 parts) is charged the vessel. The mixture is stirred at 190° C. for a further 6 hours. The product is a brown solid (95.46 parts, Acid Value 2.18 mg KOH/g).

Comparative Example A (COMPA): Intermediate 2 (455 parts) and polyphosphoric acid (107.44 parts) are stirred at 90-95° C. under a nitrogen blanket for six hours. The resulting product is dark brown oil (555 parts).

Comparative Example B (COMPB): is a 50% solution in xylene and butanol of a salt of an unsaturated polyamine amides and acidic polyesters disclosed as Example 1 of U.S. Pat. No. 3,075,849.

Comparative Example C(COMPC): is a salt of an unsaturated polyamine amides and acidic polyesters disclosed as Example 1 of U.S. Pat. No. 3,075,849.

Preparative Example 1 (PREP1): A vessel is charged with phosphorous acid (1.28 parts) and intermediate 1 (38 parts) at 150° C. and stirred for 24 hours under a nitrogen atmosphere to form a mixture. The resultant mixture has an acid value of 14.2 mgKOH/g. The mixture is allowed to cool to 65° C. and then diethanolamine (0.97 parts) is added. The mixture is stirred at 65° C. for 2 hours to give a milky white liquid which cooled to a white waxy solid (37 parts). This is dispersant 1.

Preparative Example 2 (PREP2): A vessel is charged with phosphorous acid (1.92 parts) is added to stirred intermediate 1 (38 parts) at 150° C. and the whole mixture is stirred at this temperature under a nitrogen atmosphere for 24 hours. The resultant mixture has an acid value of 30.8 mgKOH/g. The mixture is allowed to cool to 65° C. and then diethanolamine (2.13 parts) is added. The mixture is stirred at 65° C. for 2 hours to give a milky white liquid which cooled to a white waxy solid (38 parts). This is dispersant 2.

Preparative Example 3 (PREP3): A vessel is charged with phosphorous acid (5.71 parts) and Intermediate 2 (50 parts) at 150° C. and the mixture is stirred under a nitrogen atmosphere for 24 hours. The product, pale brown oil (55 parts) was poured into a storage vessel. This is dispersant 3.

Dispersants 4-27 are prepared in a manner similar to the process outlined in Preparative Example 3 except the mixture is stirred at 110° C. under a flow of nitrogen for 10 hours.

| | | | Parts | | |
|---|---|---|---|---|---|
| | | Parts | Phosphorous | Parts | Appearance of |
| Dispersant | Intermediate | Intermediate | Acid | Product | Product |
| 4 | MeOPEG550 | 50.00 | 7.45 | 55.57 | Pale yellow liquid |
| 5 | MeOPEG750 | 57.75 | 6.32 | 62.18 | Pale yellow liquid |
| 6 | 3 | 53.66 | 5.91 | 57.82 | Yellow liquid |
| 7 | 4 | 52.06 | 4.96 | 55.32 | Hazy yellow liquid |
| 8 | 5 | 50.44 | 5.97 | 51.34 | Hazy pale yellow |
| | | | | | liquid |
| 9 | 6 | 50.00 | 4.97 | 53.52 | Golden brown |
| | | | | | liquid |
| 10 | 7 | 50.00 | 5.86 | 52.03 | Yellow liquid |
| 11 | 8 | 48.92 | 5.45 | 52.49 | Brown liquid |
| 12 | 9 | 50.00 | 4.32 | 52.42 | Hazy pale yellow |
| | | | | | viscous liquid |
| 13 | 10 | 40.61 | 4.28 | 44.92 | Hazy amber liquid |
| 14 | 11 | 50.12 | 5.70 | 52.94 | Brown liquid |
| 15 | 12 | 63.40 | 7.83 | 69.04 | Amber liquid |
| 16 | 13 | 50 | 2.93 | 51.8 | Dark brown liquid |
| 17 | 14 | 31.50 | 3.14 | 32.09 | Dark brown liquid |
| 18 | 15 | 65.54 | 6.90 | 70.07 | Dark brown liquid |
| 19 | 16 | 50.00 | 5.45 | 52.07 | Brown liquid |
| 20 | 17 | 50.00 | 3.33 | 52.06 | Amber liquid |
| 21 | 18 | 44.82 | 4.46 | 46.87 | Dark brown viscous |
| | | | | | liquid |
| 22 | 19 | 43.46 | 3.96 | 45.35 | Very dark brown |
| | | | | | viscous liquid |
| 23 | 20 | 47.65 | 5.08 | 51.18 | Dark brown liquid |
| 24 | 21 | 50.00 | 5.78 | 53.21 | Hazy brown liquid |
| 25 | 22 | 40.76 | 4.73 | 42.87 | Dark brown liquid |
| 26 | 23 | 27.50 | 2.97 | 28.65 | Brown solid |
| 27 | 24 | 45.22 | 4.96 | 47.66 | Brown solid |

Dispersion Evaluation: Crystic 196 (polyester resin in styrene, Ex Scott-Bader Co., 57.14 parts) is charged to a stainless steel mill-pot and set to stir briskly. Each example dispersant (1 part active dispersant) is added and stirred into the resin for five minutes. Omyacarb™ 10 mL (calcium carbonate, ex Omya, 100 parts) filler is added gradually until substantially all of the filler is charged. The mixture is then stirred at 3000 rpm for 15 minutes to form a paste. The paste is evaluated for viscosity.

Each paste sample is measured on a TA Instruments AR2000 Controlled Stress rheometer in flow measurement mode, using a 40 mm²° C. at 20° C. The samples are sheared at rates of 0.3 s⁻¹ to 126.5 s⁻¹. The viscosity data (Pa s) obtained is as follows:

| | Shear Rate (s⁻¹) | | | | | | |
|---|---|---|---|---|---|---|---|
| | 0.3000 | 0.7114 | 1.687 | 4.001 | 9.487 | 22.50 | 53.35 |
| Control- no agent | 41.17 | 42.55 | 42.77 | 41.08 | 38.97 | 35.78 | 29.24 |
| COMPA | 23.79 | 25.16 | 26.58 | 27.82 | 27.53 | 27.36 | 23.72 |
| COMPB | 35.09 | 37.03 | 36.18 | 34.68 | 32.33 | 30.21 | 24.73 |
| COMPC | 40.94 | 42.30 | 41.70 | 39.65 | 34.92 | 32.17 | 26.61 |
| Dispersant 3 | 32.22 | 33.98 | 34.72 | 34.99 | 34.09 | 32.34 | 27.15 |
| Dispersant 4 | 12.97 | 14.06 | 14.79 | 15.05 | 14.98 | 14.99 | 14.41 |
| Dispersant 5 | 15.56 | 16.55 | 16.82 | 17.18 | 17.27 | 17.25 | 16.3 |
| Dispersant 6 | 23.14 | 24.75 | 25.78 | 26.3 | 25.8 | 25.2 | 21.23 |
| Dispersant 7 | 13.02 | 13.81 | 14.68 | 15.01 | 14.67 | 14.34 | 13.9 |
| Dispersant 8 | 19.32 | 19.30 | 18.51 | 17.49 | 16.13 | 13.69 | 12.52 |
| Dispersant 9 | 31.87 | 33.71 | 34.37 | 33.99 | 30.99 | 27.51 | 22.76 |
| Dispersant 10 | 25.55 | 27.68 | 28.77 | 29.38 | 29.34 | 29.19 | 25.17 |
| Dispersant 11 | 17.09 | 18.09 | 19.2 | 19.7 | 19.61 | 19.38 | 17.78 |
| Dispersant 12 | 26.08 | 28.38 | 30.19 | 30.79 | 30.54 | 30.13 | 25.18 |
| Dispersant 13 | 16.03 | 17.12 | 17.53 | 17.36 | 17.28 | 17.21 | 16.61 |
| Dispersant 14 | 17.09 | 18.4 | 18.9 | 18.8 | 18.48 | 18.24 | 17.64 |
| Dispersant 15 | 19.92 | 21.48 | 22.7 | 23.00 | 22.64 | 22.4 | 19.44 |
| Dispersant 16 | 19.51 | 18.96 | 18.13 | 17.82 | 16.77 | 14.33 | 13.88 |
| Dispersant 17 | 18.41 | 18.85 | 19.09 | 18.87 | 17.6 | 15.53 | 14.79 |
| Dispersant 18 | 16.46 | 17.05 | 17.55 | 17.52 | 17.33 | 17.33 | 16.81 |
| Dispersant 19 | 17.52 | 18.59 | 19.76 | 19.62 | 19.22 | 19.07 | 17.22 |
| Dispersant 20 | 16.48 | 17.96 | 19.00 | 18.85 | 18.46 | 18.09 | 16.65 |
| Dispersant 21 | 26.99 | 27.86 | 28.46 | 27.83 | 25.04 | 21.49 | 19.3 |
| Dispersant 22 | 31.70 | 32.78 | 33.28 | 31.82 | 28.13 | 24.21 | 20.47 |
| Dispersant 23 | 23.79 | 24.73 | 24.98 | 24.31 | 21.65 | 19.82 | 18.03 |
| Dispersant 24 | 17.30 | 18.43 | 19.65 | 19.79 | 19.47 | 19.17 | 17.50 |
| Dispersant 25 | 15.51 | 16.72 | 17.91 | 18.15 | 18.03 | 17.89 | 17.00 |
| Dispersant 26 | 16.59 | 17.89 | 18.77 | 19.41 | 19.20 | 19.00 | 17.52 |
| Dispersant 27 | 13.96 | 15.34 | 16.46 | 16.81 | 16.78 | 16.63 | 15.88 |

Curing Data: A vessel is charged with Crystic 196 (polyester resin in styrene, ex Scott-Bader Co., 20 parts) and Mannosec Cobalt (0.4 parts, 6% active cobalt) are stirred together for 5 minutes. Each dispersant (0.2 parts) is stirred into the activated resin. Andonox SG10 (methyl ethyl ketone peroxide, 0.2 parts) is added and stirred in for 1 minute. A thermometer probe is immersed in the resin mixture and a temperature reading is taken at 1 minute intervals. The salient data from these curing tests is presented in the table below:

| | | Time to Peak | |
|---|---|---|---|
| | Peak Exotherm | Exotherm | State of Each Cured |
| Agents | (° C.) | (minutes) | Sample |
| Control-no | 126.5 | 15 | Fully Cured at 60 |
| agent | | | minutes |
| COMPA | N/A | N/A | Does not cure |
| COMPB | 117.5 | 16 | Fully Cured at 60 |
| | | | minutes |
| Dispersant 3 | 83 | 20 | Fully Cured at 60 |
| | | | minutes |
| Dispersant 9 | 105.5 | 25 | Fully Cured at 60 |
| | | | minutes |
| Dispersant 10 | 109.3 | 24 | Fully Cured at 60 |
| | | | minutes |
| Dispersant 12 | 114.4 | 22 | Fully Cured at 60 |
| | | | minutes |
| Dispersant 16 | 113.8 | 17 | Fully Cured at 60 |
| | | | minutes |
| Dispersant 20 | 110.9 | 18 | Fully Cured at 60 |
| | | | minutes |
| Dispersant 9 | 105.5 | 25 | Fully Cured at 60 |
| | | | minutes |

The data obtained from the tests indicates that the compositions of the invention have enhanced curing performance and form improved dispersions over the compositions containing a comparative example dispersant.

Each of the documents referred to above is incorporated herein by reference. Except in the Examples, or where otherwise explicitly indicated, all numerical quantities in this description specifying amounts of materials, reaction conditions, molecular weights, number of carbon atoms, and the like, are to be understood as modified by the word “about.” Unless otherwise indicated, each chemical or composition referred to herein should be interpreted as being a commercial grade material which may contain the isomers, by-products, derivatives, and other such materials which are normally understood to be present in the commercial grade. However, the amount of each chemical component is presented exclusive of any solvent or diluent oil, which may be customarily present in the commercial material, unless otherwise indicated. It is to be understood that the upper and lower amount, range, and ratio limits set forth herein may be independently combined. Similarly, the ranges and amounts for each element of the invention may be used together with ranges or amounts for any of the other elements.

While the invention has been explained in relation to its preferred embodiments, it is to be understood that various modifications thereof will become apparent to those skilled in the art upon reading the specification. Therefore, it is to be understood that the invention disclosed herein is intended to cover such modifications as fall within the scope of the appended claims.

1. A composition comprising a particulate solid, an organic or aqueous medium and a compound obtained/obtainable by reacting:
(a) phosphorous acid;
(b) at least one member of the group consisting of an alkylene oxide, an amino carboxylic acid, a hydroxycarboxylic acid, a lactone, and a mono-, di-, tri- or polyhydroxy di-, tri- or poly-carboxylic acid; and
(c) at least one member of the group consisting of an alcohol, a thiol, a carboxylic acid, and an amine
thereby forming a compound of Formula (1) and salts thereof: 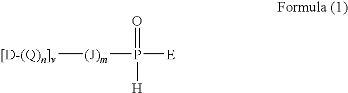
wherein
E is —OH, or an oxygen ion when the compound of Formula (1) is a salt;
Q is a repeat unit derived from an alkylene oxide, an aminocarboxylic acid, a hydroxycarboxylic acid, a lactone, or mixtures thereof;
m is 0 or 1, with the proviso that when m is 0, v is 1, and Q is linked via an oxygen of a hydroxy group to P, and via a carboxylic group to D; and when m is 1, v is 1 to 4;
J is a mono-, di-, tri- or poly-hydroxy or di-, tri- or poly-carboxylic acid residue, with the proviso that J is linked via a carboxylic group to Q and via an oxygen of a hydroxy group to P when m is 1;
D is a residue of an alcohol, a residue of a thiol, a residue of a carboxylic acid, a residue of an optionally hydrocarbyl-substituted hydroxy-containing aromatic compound, or a residue of an amine, or mixtures thereof; and
n is 0 or 100, or 1 to 100, with the proviso that when n is 0, and D is a residue of an alcohol, then the alcohol has a molecular weight of at least 200.

2. The composition of claim 1, wherein the compound is present at a range selected from 0.25 to 35 wt. %, and 0.5 to 30 wt. % of the composition.

3. The composition of claim 1, wherein the organic medium is an organic liquid or a plastic material.

4. The composition of claim 1, wherein the organic liquid comprises at least 0.1% by weight of a polar organic liquid based on the total organic liquid.

5. The composition of claim 1, wherein the particulate solid is a pigment.

6. The use of a compound as a dispersant, wherein the compound is obtained/obtainable by reacting:
(a) phosphorous acid;
(b) at least one member of the group consisting of an alkylene oxide, an amino carboxylic acid, a hydroxycarboxylic acid, a lactone, and a mono-, di-, tri- or polyhydroxy di-, tri- or poly-carboxylic acid; and
(c) at least one member of the group consisting of an alcohol, a thiol, a carboxylic acid, and an amine.

7. A composition comprising a particulate solid, an organic or aqueous medium and a compound of Formula (1) and salts thereof: 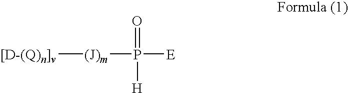
wherein
E is —OH, or an oxygen ion when the compound of Formula (1) is a salt;
Q is a repeat unit derived from an alkoxylate, an aminocarboxylic acid, a hydroxycarboxylic acid, a lactone, a residue of a dicarboxylic acid and diol, or mixtures thereof;
m is 0 or 1, with the proviso that when m is 0, v is 1, and Q is linked via an oxygen of a hydroxy group to P, and via a carboxylic group to D-Q; and when m is 1, v is 1 to 4;
J is a mono-, di-, tri- or poly-hydroxy or di-, tri- or poly-carboxylic acid residue;
D is a residue of an alcohol, a residue of a thiol, a residue of a carboxylic acid, a residue of an optionally hydrocarbyl-substituted hydroxy-containing aromatic compound, or a residue of an amine, or mixtures thereof; and
n is 0 or 100, or 1 to 100, with the proviso that when n is 0, and D is a residue of an alcohol, then the alcohol has a molecular weight of at least 200.

8. The composition of claim 7, wherein the compound of Formula (1) is represented by
E is —OH, or an oxygen ion when the compound of Formula (1) is a salt;
Q is a repeat unit derived from an alkoxylate, or a hydroxycarboxylic acid, or a lactone, or mixtures thereof, which is linked via an oxygen of a hydroxy group to P, and via a carboxylic group to D, or mixtures thereof;
J is a mono-, di-, tri- or poly-hydroxy or di-, tri- or poly-carboxylic acid residue;
D is a residue of an alcohol, a residue of a thiol, a residue of a carboxylic acid, a residue of an optionally hydrocarbyl-substituted hydroxy-containing aromatic compound, and a residue of a mono-amine represented by the general formula R—O—(Y)ₓ-T-N(G)-, or a residue of a diamine represented by the general formula R′-N(G′)-T-O—(Y)ₓ-T-N(G)-), or mixtures thereof;
n is 0 or 100;
R and R′ are independently H or C₁₋₅₀-optionally substituted hydrocarbyl, or C₁₋₅₀-optionally substituted hydrocarbonyl, or the residue of an epoxide;
Y is C₂₋₄-alkyleneoxy;
T is C₂₋₄ alkylene;
G and G′ are independently H or C₁₋₅₀-optionally substituted hydrocarbyl or C₁₋₅₀-optionally substituted hydrocarbonyl; and
x is 2 to 90.

9. The composition of claim 7, wherein D of Formula (1) is a residue of a diamine represented by the general formula R′-N(G′)-T-O—(Y)ₓ-T-N(G)-), or mixtures thereof, R′ is independently H or C₁₋₅₀-optionally substituted hydrocarbyl, or C₁₋₅₀-optionally substituted hydrocarbonyl, or the residue of an epoxide.

10. The composition of claim 7, wherein D of Formula (1) is a residue of a monoamine represented by the general formula R—O—(Y)ₓ-T-N(G)-, or mixtures thereof, R is independently H or C₁₋₅₀-optionally substituted hydrocarbyl, or C₁₋₅₀-optionally substituted hydrocarbonyl, or the residue of an epoxide.

11. The composition of claim 7, wherein the compound of Formula (1) is present at 0.1 to 50 wt % of the composition.

12. The composition of claim 7, wherein the compound of Formula (1) defines:
(i) D as a residue of an alcohol, a residue of a thiol, a residue of a carboxylic acid, a residue of an optionally hydrocarbyl-substituted hydroxy-containing aromatic compound, or a residue of amine; and
(ii) Q has the general Formula (2)-[AO]ⱼ[BU]ₖ—,
wherein
the sum of j and k is 1 to 100;
AO represents a residue of an alkylene oxide; and
BU represents a residue of an amino carboxylic acid, a residue of a mono-hydroxy carboxylic acid, a residue of a lactone, or mixtures thereof.

13. The composition of claim 7, wherein Y is a mixture of C₃₋₄-alkyleneoxy where the chain represented by (Y)ₓ is in part —CH₂CH₂CH₂CH₂O—, —CH₂CH(CH₃)O— or —CH₂—CH(CH₂—CH₃)—O—, with up to 100% ethyleneoxy groups present.

14. The composition of claim 7, wherein the [D-(Q)ₙ]ᵥ-(J)ₘ- group of Formula (1) has a number average molecular weight of 200 to 10,000, or 200 to 5000, or 300 to 3000.

15. A compound of Formula (1) and salts thereof: 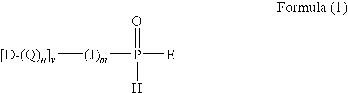
wherein
E is —OH, or an oxygen ion when the compound of Formula (1) is a salt;
Q is a repeat unit derived from an alkylene oxide, an aminocarboxylic acid, a hydroxycarboxylic acid, a lactone, or mixtures thereof;
m is 0 or 1, with the proviso that when m is 0, v is 1, and Q is linked via an oxygen of a hydroxy group to P, and via a carboxylic group to D; and when m is 1, v is 1 to 4;
J is a mono-, di-, tri- or poly-hydroxy or di-, tri- or poly-carboxylic acid residue, with the proviso that J is linked via a carboxylic group to Q and via an oxygen of a hydroxy group to P when m is 1;
D is a residue of an alcohol, a residue of a thiol, a residue of a carboxylic acid, a residue of an optionally hydrocarbyl-substituted hydroxy-containing aromatic compound, or a residue of an amine, or mixtures thereof; and
n is 0 or 100, or 1 to 100, with the proviso that when n is 0, and D is a residue of an alcohol, then the alcohol has a molecular weight of at least 200.

16. The compound of claim 15, wherein the alcohol of D has a molecular weight of 225 to 8000, or 500 to 2500 when n is 0.

17. The compound of claim 15, wherein n is 0 to 1, with the proviso that when n is 0, D is a residue of a thiol, a residue of a carboxylic acid, a residue of a optionally hydrocarbyl-substituted hydroxy-containing aromatic compound, and a residue of amine, or mixtures thereof.
